(19) United States
(12) Patent Application Publication
(10) Pub. No.: US 2021/0294830 A1
(43) Pub. Date: Sep. 23, 2021

(54) MACHINE LEARNING APPROACHES TO IDENTIFY NICKNAMES FROM A STATEWIDE HEALTH INFORMATION EXCHANGE

(71) Applicant: The Trustees of Indiana University, Indianapolis, IN (US)

(72) Inventors: Suranga Nath Kasthurirathne, Indianapolis, IN (US); Shaun Jason Grannis, Indianapolis, IN (US)

(21) Appl. No.: 17/205,765

(22) Filed: Mar. 18, 2021

Related U.S. Application Data
(60) Provisional application No. 62/991,911, filed on Mar. 19, 2020.

(51) Int. Cl. G06F 16/35; G06N 5/00; G06N 20/00; G06F 40/295

(52) U.S. Cl. CPC G06F 16/35; G06F 40/295; G06N 20/00; G06N 5/003

(57) ABSTRACT

Methods and systems disclosed herein relate to using machine learning to identify names from a database. In an exemplary embodiment, a name identification system comprises a database including a plurality of name pairs. The name identification system also comprises a computing device operatively coupled with the database. The computing device is configured to perform the following: extract the plurality of name pairs from the database; calculate features for each name pair from the plurality of name pairs; assign a name pair data vector to the each name pair based on the features calculated for the each name pair; separate the name pair data vectors into a training dataset and a holdout dataset; train a decision model, via machine learning, based on the training dataset; apply the decision model to the holdout dataset; and evaluate the decision model.

### CROSS-REFERENCE TO RELATED APPLICATIONS

The present application claims the benefit of U.S. Provisional Application No. 62/991,911, filed Mar. 19, 2020, the complete disclosure of which being hereby expressly incorporated herein by reference.

### GOVERNMENT SUPPORT CLAUSE

This invention was made with government support under HS023808 awarded by National Institutes of Health. The government has certain rights in the invention.

### FIELD OF THE DISCLOSURE

The present disclosure relates to the field of machine learning, and more specifically to using machine learning to identify names from a database.

### BACKGROUND OF THE DISCLOSURE

Patient matching is essential to minimize fragmentation of patient data. However, the siloed implementation of health information systems, for example the Health Information Exchange (HIE), and legal restrictions preventing the use of a national level patient identifier, has led to the fragmentation of patient information in databases across the United States. Fragmentation impedes the delivery of quality patient care by preventing providers from accessing complete patient records, causing inefficiencies and delays, hindering public health reporting, and leading to enhanced patient risk.

Patient matching accuracy is strongly influenced by the quality and accessibility of data required. Certain data elements may be costly to obtain, incomplete, or incorrect. Further, not all data elements contribute equally towards matching. Patient name elements are widely collected and commonly used pieces of identification within the healthcare system. However, inconsistencies in the usage and reporting of names, such as the use of nicknames, pose a significant challenge to patient matching. As such, there is a need to develop decision models capable of identifying names more effectively in various patient databases.

### SUMMARY OF THE DISCLOSURE

The present disclosure relates to using machine learning to identify names from a database. Exemplary embodiments include but are not limited to the following:

In an Example 1, a name identification system comprises: a database including a plurality of name pairs; a computing device operatively coupled with the database, the computing device configured to perform the following: extract the plurality of name pairs from the database; calculate features for each name pair from the plurality of name pairs; assign a name pair data vector to the each name pair based on the features calculated for the each name pair; separate the name pair data vectors into a training dataset and a holdout dataset; train a decision model, via machine learning, based on the training dataset; apply the decision model to the holdout dataset; and evaluate the decision model.

In an Example 2, the name identification system of Example 1, wherein the features represent phonetical and structural similarity between the each name pair.

In an Example 3, the name identification system of Example 1, wherein the name pair data vectors define which of the features agree for the name pairs.

In an Example 4, the name identification system of Example 1, wherein a ratio of the training dataset to the holdout dataset is 9:1.

In an Example 5, the name identification system of Example 1, wherein the decision model is trained by performing a hyperparameter tuning using multiple versions of the training dataset that are balanced using different boosting levels.

In an Example 6, the name identification system of Example 1, wherein the decision model is evaluated by calculating a Positive Predictive Value (PPV) of the decision model.

In an Example 7, the name identification system of Example 1, wherein the decision model is evaluated by preparing precision-recall curves of the decision model.

In an Example 8, a method of automatic name identification using a computing device, comprises: extracting, by the computing device, a plurality of name pairs from a database; calculating, by the computing device, features for each name pair from the plurality of name pairs; assigning, by the computing device, a name pair data vector to the each name pair based on the features calculated for the each name pair; separating, by the computing device, the name pair data vectors into a training dataset and a holdout dataset; training, by the computing device via machine learning, a decision model based on the training dataset; applying, by the computing device, the decision model to the holdout dataset; and evaluating, by the computing device, the decision model.

In an Example 9, the method of Example 8, wherein the features represent phonetical and structural similarity between the each name pair.

In an Example 10, the method of Example 8, wherein the name pair data vectors define which of the features agree for the name pairs.

In an Example 11, the method of Example 8, wherein a ratio of the training dataset to the holdout dataset is 9:1.

In an Example 12, the method of Example 8, wherein the decision model is trained by performing a hyperparameter tuning using multiple versions of the training dataset that are balanced using different boosting levels.

In an Example 13, the method of Example 8, wherein the decision model is evaluated by calculating a Positive Predictive Value (PPV) of the decision model.

In an Example 14, the method of Example 8, wherein the decision model is evaluated by preparing precision-recall curves of the decision model.

### BRIEF DESCRIPTION OF THE DRAWINGS

The features of this disclosure, and the manner of attaining them, will become more apparent and the disclosure itself will be better understood by reference to the following description of embodiments of the disclosure taken in conjunction with the accompanying drawings. In the figures, like reference numerals represent like elements, and the figures are to be understood as illustrative of the disclosure. The figures are not necessarily drawn to scale and are not intended to be limiting in any way.

FIG. 1 is a flow diagram of a decision model according to an embodiment.

FIG. 2 is a graph showing frequencies of true nickname matches according to an embodiment.

FIG. 3 is another graph showing frequencies of non-nickname matches according to an embodiment.

FIGS. 4A and 4B are graphs showing the precision-recall curves according to an embodiment.

FIG. 5 shows a flow diagram of a method for automatically identifying nicknames from database using machine learning according to an embodiment.

While the present disclosure is amenable to various modifications and alternative forms, specific embodiments have been shown by way of example in the drawings and are described in detail below. The intention, however, is not to limit the present disclosure to the particular embodiments described. On the contrary, the present disclosure is intended to cover all modifications, equivalents, and alternatives falling within the scope of the present disclosure as defined by the appended claims.

### DETAILED DESCRIPTION

In the following detailed description, reference is made to the accompanying drawings which form a part hereof, and in which is shown by way of illustration specific embodiments in which the present disclosure is practiced. These embodiments are described in sufficient detail to enable those skilled in the art to practice the present disclosure, and it is to be understood that other embodiments can be utilized and that structural changes can be made without departing from the scope of the present disclosure. Therefore, the following detailed description is not to be taken in a limiting sense, and the scope of the present disclosure is defined by the appended claims and their equivalents.

Patient name elements are widely collected and commonly used pieces of identification used within the healthcare system. However, inconsistencies in the usage and reporting of names pose a significant challenge to patient matching. Some inconsistencies may be caused by misspellings, which conventional patient matching tools address using string comparators. However, string comparators may not address inconsistencies resulting from use of nicknames. Consequently, supplementing existing patient demographic data with imputed nickname information may improve the accuracy of patient matching.

Nicknames are widely used and researchers have documented evidence of phonological and structural patterns in their use. For example, nicknames can be phonologically similar to given name (e.g., “Kathryn” and “Kitty”); they may be based on structural variations such as spelling variations (e.g., “Vicki” and “Vickie”), diminutive variations (e.g., the diminutive “Betty” to the more formal “Elizabeth”) and cross the gender divide (e.g., the nickname “Andy” may be used for both the female “Andrea” as well as the male “Andrew”). However, manually creating nickname lookup tables relevant to a specific population requires significant effort. Further, such efforts would be limited by the reviewers' knowledge and perception of nicknames. An alternate approach is to develop decision models to impute nickname pairs based on phonological and lexical similarity. Approaches for evaluating phonological similarity and/or patterns in names have been developed previously and include string comparators, phonological similarity measures, N-gram distributions that evaluate term similarities, as well as various algorithms that predict race/ethnicity and gender. These methods present significant potential to provide a wide range of information on the structure and phonological similarity of English nicknames.

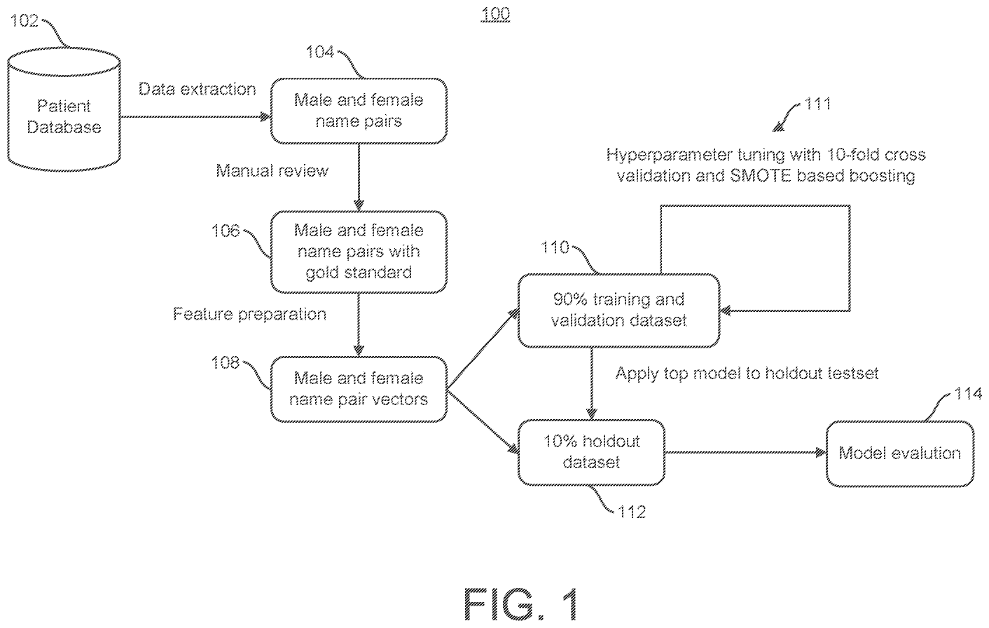

FIG. 1 shows an example of a decision model that can identify true nicknames using features representing the phonetical and structural similarity of nickname pairs as presently disclosed according to some embodiments. Workflow 100 is shown presenting a study approach from data extraction to decision model evaluation according to some embodiments. From a patient database 102, data extraction may be performed to obtain pairs 104 of male and female names. According to some examples, patient data may be extracted from the master person index of the Indiana Network for Patient Care (INPC), one of the longest continuously running HIE's in the United States. The INPC covers 23 health systems, 93 hospitals and over 40,000 providers. To date, the INPC contains data on over 15 million patients having more than 25 million registrations (the same patient can be registered at multiple HIE participants). The INPC's patient matching service is used to identify the same patient across multiple institutions. Next, first names are analyzed for all patients with multiple registrations, and the “name pairs” 104 are created when first name for the same patient differed for separate registrations. All name pairs with (1) mismatching or missing genders, (2) occurred 3 times or less, or (3) contained invalid phrases such as MALE, FEMALE, BOY, GIRL or BABY are excluded. For name pairs with frequencies ranging between 3 and 20, any pairs with Jaro-Winkler or Longest Common Subsequence (LCS) scores of 0 are also removed. The remaining name pairs are split into male and female genders, and serves as the name pair dataset.

The name pairs 104 may then be reviewed to obtain gold standard 106 of male and female name pairs. This review may be performed manually. According to some examples, each first name pair may be reviewed by two independent reviewers who tagged each name pair as TRUE (is a nickname) or FALSE (not a nickname). In the event of a disagreement, a third reviewer served as a tiebreaker. Reviewers selected diminutive nicknames as well as nicknames based on phonological and lexical similarities. Nicknames based on familial relationships (“Sr.” for father and “Jr.” or “Butch” for son), order of birth or occupation (“Doc” or “Doctor” used for either a 7th child or a physician) as well as those based on external attributes or personality (“Blondie”, “Ginger”, “Brains” etc.) are not considered.

A number of features may be calculated to represent the phonological and lexical similarity of each first name pair under study as shown in Table 1 below.

TABLE 1
Features calculated per each first name pair

| Feature name | Description |
|---|---|
| Frequency | Number of times that the name pair under |
| | consideration appeared in the INPC dataset |
| Modified | String comparator which computes the number of |
| Jaro-Winkler | common characteristics in two strings, and finds the |
| comparator | number of transpositions for one string to be modified |
| (JWC) | to the other. |
| Longest common | String comparator which generates a nearness metric |
| substring | by iteratively locating and deleting the longest |
| (LCS) | common substring between two strings. |
| Levenstein | String comparator which calculates the minimum |
| edit distance | number of single character edits (insertions, deletions |
| (LEV) | or substitutions) necessary to change one string into |
| | the other |
| Combined Root | The combined root mean square score of JWC, LCS |
| mean square | and LEV string comparators. |

A number of features may also calculated for each individual name in each name pair as shown in Table 2 below.

TABLE 2
Features calculated per each name

| Feature name | Description |
|---|---|
| Race/ethnicity | We used the python ethnicolr package to categorize each name |
| | into one of the following categories; white, black, Asian or |
| | Hispanic. |
| Gender | We used the python gender-guesser package to categorize each |
| | name into one of the following categories; male, female, |
| | androgynous (name may beused by both male and female |
| | genders) and unknown. |
| Soundex | Phonetic encoding algorithm based on word pronunciation, rather |
| | than how they are spelled. |
| Metaphone | Phonetic encoding algorithm which includes special rules for |
| | handling spelling inconsistencies as well as looking at |
| | combinations of consonants and vowels. |
| The New York | Phonetic encoding algorithm with 11 basic rules that replace |
| State | common pronunciation variations with standardized characters, |
| Identification and | remove common characters and replace all vowels with the letter |
| Intelligence | “A”. The NYSIIS algorithm is more advanced than other phonetic |
| System algorithm | algorithms as it is able to handle phonemes that occur in European |
| (NYSIIS) | and Hispanic surnames. |
| Number of | We developed a java program that counts the number of syllables |
| syllables | in each name using existing language rules. The validity of the |
| | program is assessed via manual review of test data. |
| Bi-Gram | Researchers have calculated bi-gram frequencies of English |
| frequencies | words. Frequently occurring bi-grams may represent common |
| | phonological sounds. Thus, names that contain multiple |
| | commonly occurring phonological sounds have a much higher |
| | chance of representing nicknames. We calculated a normalized |
| | score representing the frequency of bi-gram counts for each name. |
| Misspelling | By computing appearance of bi-grams that occur very |
| frequencies | infrequently, we also calculated a measure for potential |
| | misspellings. |

In addition to the string comparators listed in Table 2, a binary feature agreement vector may be also created indicating which of these features agreed for each name pair. For male and female name pairs, name pair vectors 108 may be developed consisting of the feature sets described in Tables 1 and 2 and the binary feature agreement vector.

In some examples, python and the scikit-learn machine learning library may be leveraged to build XGBoost classification models to identify nicknames across male and female name vectors. The XGBoost algorithm is an implementation of gradient boosted ensemble of decision trees designed for speed and performance. XGBoost classification is selected because (a) ensemble decision trees performed compatibly or better than other classification algorithms, and (b) the algorithm has demonstrated superior performance to other classification algorithms.

Such models may be built to address data imbalance present in both name vectors, as well as model overfitting. Each data vector may be split into random groups of 90% (training and validation dataset 110) and 10% (holdout test set 112). After an exploratory analysis, Synthetic Minority Oversampling Technique (SMOTE) 111 may be adopted to boost the imbalanced class (nicknames match). Oversampling involves increasing the number of the samples from a minority class in the training dataset. The common method is to add copies of data points from the minority class, which amplifies the decision region resulting in the improvement of evaluation metrics. To reduce overfitting, SMOTE may be used, which is an enhanced sampling method that creates synthetic samples based on the nearest neighbors of feature values in the minority class. However, various levels of boosting may have different impact on model performance. Similarly, the XGBoost algorithm consist of multiple parameters which could each impact model performance. Thus, it may be decided to perform hyperparameter tuning using multiple versions of the training dataset that had been balanced using different boosting levels. Hyperparameter tuning may be performed using randomized search and 10-fold cross validation. Features that may be modified as part of the hyperparameter tuning process are listed in Table 3, according to some embodiments.

TABLE 3
Parameters that are modified as part of the hyperparameter process.

| Hyperparameter | Description |
|---|---|
| Boosting ratio | Level of boosting performed using SMOTE |
| Number of | Number of trees |
| estimators | |
| Minimum child | Minimum sum of weights of all observations required |
| weight | in a child |
| Gamma value | the minimum loss reduction required to split a node |
| Subsample | Fraction of observations to be randomly samples for |
| | each tree |
| Col sample by | Fraction of columns to be randomly samples for each |
| tree | tree |
| Max depth | Maximum depth of each tree |

Model evaluation 114 may be subsequently performed. The best performing models identified by hyperparameter tuning may be applied to the holdout test datasets, which are not artificially balanced via boosting. This ensures that the best decision model would be evaluated against a holdout dataset with the original prevalence of nickname pairs, ensuring that the model may be suitable for implementation.

Positive Predictive Value (PPV) may be also calculated. The PPV is defined by the precision, sensitivity, accuracy and F1-score for each decision model under test. Sensitivity is also known as recall, and the F1-score is the harmonic mean between precision and recall. Traditionally, area under a Receiver Operating Characteristic (ROC) curve (a.k.a. “area under curve” or AUC) is considered an important performance metric. However, precision-recall curves may be more accurate than AUC curves for evaluating unbalanced datasets in some examples. Thus, precision-recall curves may be prepared for each decision model.

According to one implementation of the aforesaid embodiment, a total of 11,986 male name pairs and 15,252 female name pairs may be identified. The manual review of these identified 291 (2.428%) of the male name pairs and 671 (4.4%) of the female name pairs as true nicknames. Kappa scores for male and female nickname reviews, as performed by the two primary reviewers are 0.810 and 0.791 respectively. These scores indicate very high levels of inter-rater reliability in the manual review process.

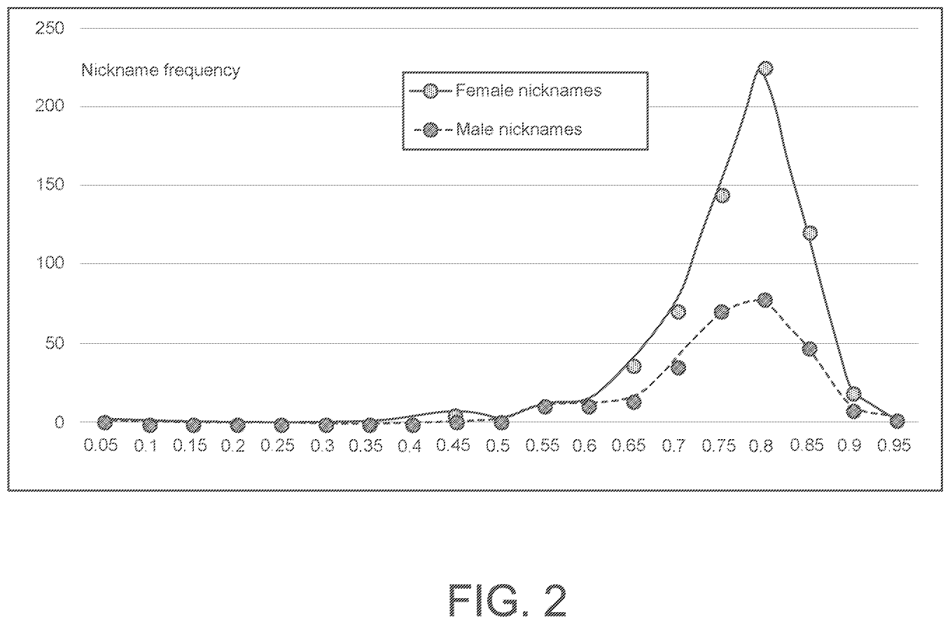

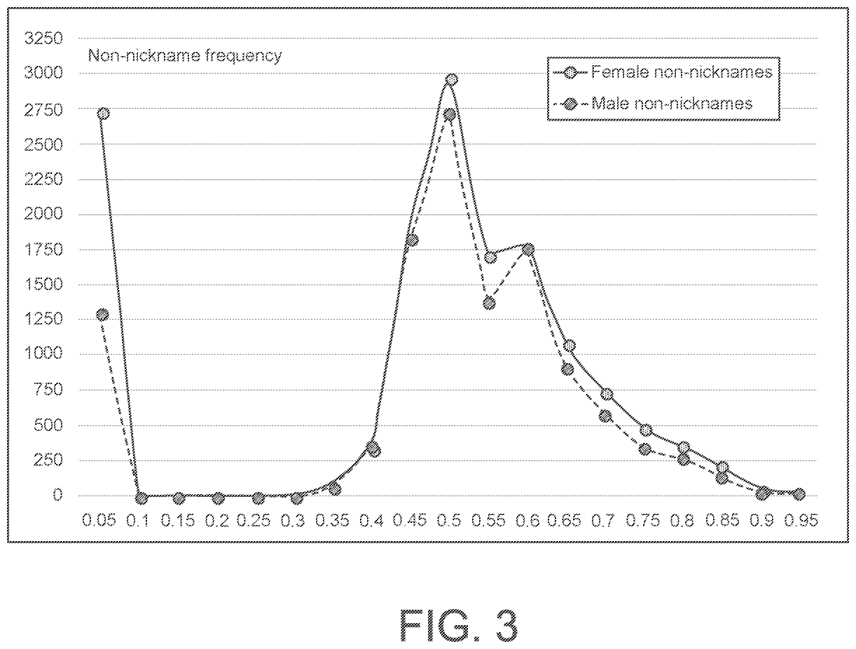

FIG. 2 presents a breakdown of the frequency of true nickname matches as a function of Jaro-Winkler scores for male and female name pairs. The preponderance of male and female nickname match scores for true nicknames ranged from 0.7 to 0.85, with a steep drop as the score approached 1. As presented in FIG. 3, frequency of the majority of non-nickname pair scores for male and female datasets ranged between 0-0.05. Pair frequency dropped to 0 from Jaro-Winkler scores between 0.1 and 0.3, after which they rose significantly until Jaro-Winkler scores of 0.5. Frequencies for both male and female datasets fell drastically as Jaro-Winkler scores are increased further.

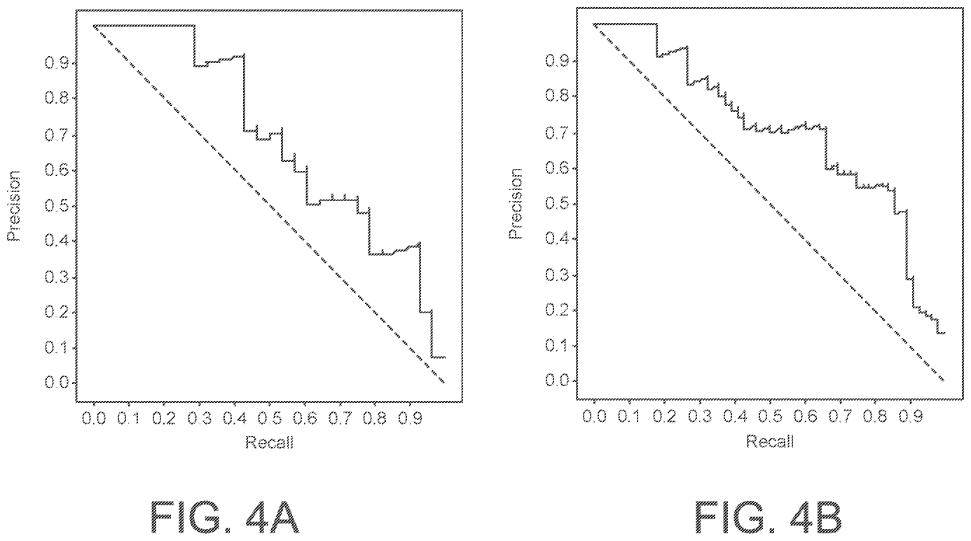

Table 4 shown below reports the predictive performance of optimum decision models selected by hyperparameter tuning applied to the holdout test datasets. FIGS. 4A and 4B present the precision-recall curves reported by these models. Precision-recall curve reported by male nickname prediction model is shown in FIG. 4A, and precision-recall curve reported by female nickname prediction model is shown in FIG. 4B. Table 5 lists some of the features that contributed to the male and female decision models, according to some embodiments. Importance may be determined by the XGBoost classification algorithm's internal feature selection process which evaluates the number of times a feature is used to split the data across all trees.

TABLE 4
Predictive performance of the machine learning
models applied to the holdout test datasets

| | Male nickname | Female nickname |
|---|---|---|
| Performance measure | model (%) | model (%) |
| Positive Predictive Value | 85.71 | 70.59 |
| (PPV) a.k.a. precision | | |
| Sensitivity, a.k.a. recall | 42.86 | 64.29 |
| Accuracy | 98.50 | 97.71 |
| F1-score | 57.14 | 67.29 |

TABLE 5
List of top ranking features that contributed to male
and female decision models (cutoff = 0.5 selected
based on variance in feature importance scores).

| Male nickname model | | Female nickname model | |
|---|---|---|---|
| | Feature | | Feature |
| | importance | | importance |
| Feature name | (0-1) | Feature name | (0-1) |
| Syllable count | 0.997 | Soundex | 0.995 |
| comparison | | comparison | |
| Soundex | 0.995 | Syllable count | 0.994 |
| comparison | | comparison | |
| Levenstien edit | 0.9915 | Race/Ethnicities | 0.9935 |
| distance | | match | |
| Gender match | 0.985 | Levenstien edit | 0.98 |
| | | distance | |
| Frequency | 0.979 | Frequency | 0.98 |
| Race/Ethnicities | 0.97 | Gender match | 0.975 |
| match | | | |
| Combined Root | 0.962 | Combined Root | 0.971 |
| Mean Square | | Mean Square | |
| NYSIIS | 0.935 | Bi-gram frequency | 0.955 |
| comparison | | comparison | |
| Metphone | 0.92 | Misspelling | 0.953 |
| comparison | | frequencies | |
| Jaro Winkler | 0.832 | Metphone | 0.95 |
| comparator | | comparison | |
| Bi-gram frequency | 0.65 | Jaro Winkler | 0.85 |
| comparison | | comparator | |
| | | NYSIIS | 0.7 |
| | | comparison | |

In some examples, the ratio of true nickname matches to false nickname pairs may be boosted to 0.2 for the male nickname model, and 0.3 for the female nickname model in decision models. Despite the highly imbalanced nature of the holdout test datasets, decision models performed significantly well with high precision/PPV scores. Both models reported exceptionally high accuracy scores (>97%). The high accuracy scores may be attributed to the unbalanced data of the test data being used. Both models also reported mid-level sensitivity/recall and F1-scores. The weak F1-score may be justified on the grounds that it represents a balance between precision and recall.

According to some examples, analysis reveals that the use of nicknames may be higher among females (4.4%) than males (2.4%) within the HIE dataset. The high precision/PPV achieved by each decision model suggests suitability for use in the healthcare domain, where accurately matching patient records is a crucial function. Further, the male nickname model reported significantly high precision/PPV scores despite the male name pair dataset being more imbalanced than the female name pair dataset, while the sensitivity/recall and F1-scores produced by the male nickname model may be lower than the female models. These decision models may be generated using name pairs from a large scale HIE encompassing 23 health systems, 93 hospitals and over 40,000 providers.

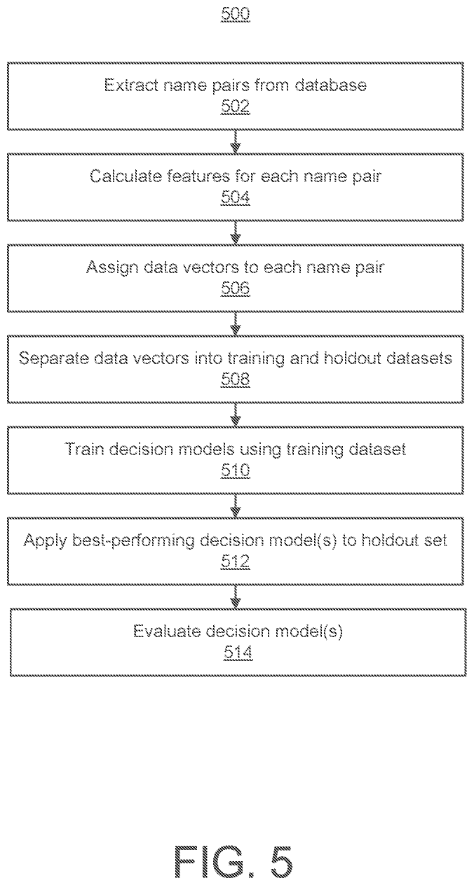

FIG. 5 shows a method 500 for implementing the machine learning model according to some embodiments. The machine learning may be implemented via a name detection circuit implemented in a computing device, such as a computer, smart device, server, etc., that has one or more processing unit(s) to perform the machine learning steps in the method 500. A circuit may be implemented in hardware and/or as computer instructions on a non-transient computer readable storage medium, and such circuits may be distributed across various hardware or computer based components. The computing device or computing system may include a microprocessor, an application-specific integrated circuit (ASIC), a field-programmable gate array (FPGA), etc., or combinations thereof. The computing system may include memory which may include, but is not limited to, electronic, optical, magnetic, or any other storage or transmission device capable of providing a processor, ASIC, FPGA, etc. with program instructions. The memory may include a memory chip, electrically erasable programmable read-only memory (EEPROM), erasable programmable read only memory (EPROM), flash memory, or any other suitable memory from which the computing system can read instructions. The instructions may include code from any suitable programming language. The computing system may be a single device or a distributed device, and the functions of the computing system may be performed by hardware and/or as computer instructions on a non-transient computer readable storage medium.

The computing device receives the name pairs from the computer readable medium in step 502, where the name pairs may be selected based on phonological and lexical similarities. For example, one name may be the given name and the other name may be phonologically similar to the given name, a structural variation such as a spelling variation of the given name, a diminutive variation of the given name, and so on.

The computing device calculates features for each of the name pairs in step 504. The features include, in some examples, the frequency in which such name pairs appear in the database, the number of common characteristics between the pair of names, the number of differences between the pair of names, etc. Additional features that may be calculated include one or more of: race and ethnicity likely pertaining to each name pair, gender, pronunciation or phonetic characteristics, number of syllables, potential for misspellings, and so on.

Data vectors may be assigned for each name pair in step 506. The vectors indicate the aforementioned features for each name pair, as well as whether the features agree for each name pair.

The data vectors may be separated into training dataset and holdout dataset in step 508. The ratio of the training dataset to the holdout dataset may be 9:1 according to some examples, or any other ratio as deemed suitable such as 4:1, 19:1, 49:1, 99:1, etc. The computing device trains decision models via machine learning based on the training dataset in step 510, where the training dataset undergoes a hyperparameter optimization, or tuning, using k-fold cross-validation, which involves randomly dividing the training dataset into k groups, or folds, of approximately equal size. The first fold may be treated as a validation set, and the method may be fit on the remaining k−1 folds. In some examples, the hyperparameter optimization may be performed using randomized search and 10-fold cross validation.

In step 512, after the decision models are optimized or tuned according to step 510, the computing device applies the best performing decision model(s) identified by the hyperparameter optimization to the holdout dataset. Then, the performing model(s) may be evaluated in step 514 by the computing device.

The schematic flow chart diagrams and method schematic diagrams described above are generally set forth as logical flow chart diagrams. As such, the depicted order and labeled steps may be indicative of representative embodiments. Other steps, orderings and methods may be conceived that are equivalent in function, logic, or effect to one or more steps, or portions thereof, of the methods illustrated in the schematic diagrams.

Additionally, the format and symbols employed may be provided to explain the logical steps of the schematic diagrams and are understood not to limit the scope of the methods illustrated by the diagrams. Although various arrow types and line types may be employed in the schematic diagrams, they are understood not to limit the scope of the corresponding methods. Indeed, some arrows or other connectors may be used to indicate only the logical flow of a method. For instance, an arrow may indicate a waiting or monitoring period of unspecified duration between enumerated steps of a depicted method. Additionally, the order in which a particular method occurs may or may not strictly adhere to the order of the corresponding steps shown. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

Many of the functional units described in this specification have been labeled as circuits, in order to more particularly emphasize their implementation independence. For example, a circuit may be implemented as a hardware circuit comprising custom VLSI circuits or gate arrays, off-the-shelf semiconductors such as logic chips, transistors, or other discrete components. A circuit may also be implemented in programmable hardware devices such as field programmable gate arrays, programmable array logic, programmable logic devices or the like.

Circuits may also be implemented in machine-readable medium for execution by various types of processors. An identified circuit of executable code may, for instance, comprise one or more physical or logical blocks of computer instructions, which may, for instance, be organized as an object, procedure, or function. Nevertheless, the executables of an identified circuit need not be physically located together, but may comprise disparate instructions stored in different locations which, when joined logically together, comprise the circuit and achieve the stated purpose for the circuit.

Indeed, a circuit of computer readable program code may be a single instruction, or many instructions, and may even be distributed over several different code segments, among different programs, and across several memory devices. Similarly, operational data may be identified and illustrated herein within circuits, and may be embodied in any suitable form and organized within any suitable type of data structure. The operational data may be collected as a single data set, or may be distributed over different locations including over different storage devices, and may exist, at least partially, merely as electronic signals on a system or network. Where a circuit or portions of a circuit are implemented in machine-readable medium (or computer-readable medium), the computer readable program code may be stored and/or propagated on in one or more computer readable medium(s).

The computer readable medium may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. Computer readable program code embodied on a computer readable signal medium may be transmitted using any appropriate medium, including but not limited to wireless, wireline, optical fiber cable, Radio Frequency (RF), or the like, or any suitable combination of the foregoing.

In one embodiment, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

Computer readable program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The computer readable program code may execute entirely on the user's computer, partly on the user's computer, as a stand-alone computer-readable package, partly on the user's computer and partly on a computer or entirely on the computer or server. In the latter scenario, the computer may be connected to the user's computer through any type of network, including a local area network (LAN) or a wide area network (WAN), or the connection may be made to an external computer (for example, through the Internet using an Internet Service Provider).

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Accordingly, the present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope. No claim element herein is to be construed under the provisions of 35 U.S.C. § 112, sixth paragraph, unless the element is expressly recited using the phrase “means for.”

What is claimed is:

1. A name identification system comprising:
a database including a plurality of name pairs;
a computing device operatively coupled with the database, the computing device configured to perform the following:
extract the plurality of name pairs from the database;
calculate features for each name pair from the plurality of name pairs;
assign a name pair data vector to the each name pair based on the features calculated for the each name pair;
separate the name pair data vectors into a training dataset and a holdout dataset;
train a decision model, via machine learning, based on the training dataset;
apply the decision model to the holdout dataset; and
evaluate the decision model.

2. The name identification system of claim 1, wherein the features represent phonetical and structural similarity between the each name pair.

3. The name identification system of claim 1, wherein the name pair data vectors define which of the features agree for the name pairs.

4. The name identification system of claim 1, wherein a ratio of the training dataset to the holdout dataset is 9:1.

5. The name identification system of claim 1, wherein the decision model is trained by performing a hyperparameter tuning using multiple versions of the training dataset that are balanced using different boosting levels.

6. The name identification system of claim 1, wherein the decision model is evaluated by calculating a Positive Predictive Value (PPV) of the decision model.

7. The name identification system of claim 1, wherein the decision model is evaluated by preparing precision-recall curves of the decision model.

8. A method of automatic name identification using a computing device, comprising:
extracting, by the computing device, a plurality of name pairs from a database;
calculating, by the computing device, features for each name pair from the plurality of name pairs;
assigning, by the computing device, a name pair data vector to the each name pair based on the features calculated for the each name pair;
separating, by the computing device, the name pair data vectors into a training dataset and a holdout dataset;
training, by the computing device via machine learning, a decision model based on the training dataset;
applying, by the computing device, the decision model to the holdout dataset; and
evaluating, by the computing device, the decision model.

9. The method of claim 8, wherein the features represent phonetical and structural similarity between the each name pair.

10. The method of claim 8, wherein the name pair data vectors define which of the features agree for the name pairs.

11. The method of claim 8, wherein a ratio of the training dataset to the holdout dataset is 9:1.

12. The method of claim 8, wherein the decision model is trained by performing a hyperparameter tuning using multiple versions of the training dataset that are balanced using different boosting levels.

13. The method of claim 8, wherein the decision model is evaluated by calculating a Positive Predictive Value (PPV) of the decision model.

14. The method of claim 8, wherein the decision model is evaluated by preparing precision-recall curves of the decision model.

15. One or more computer-readable media having non-transitory computer-executable instructions embodied thereon that, when executed by a processor, cause the processor to:
extract the plurality of name pairs from the database;
calculate features for each name pair from the plurality of name pairs;
assign a name pair data vector to the each name pair based on the features calculated for the each name pair;
separate the name pair data vectors into a training dataset and a holdout dataset;
train a decision model, via machine learning, based on the training dataset;
apply the decision model to the holdout dataset; and
evaluate the decision model.

16. The computer-readable media of claim 15, wherein the features represent phonetical and structural similarity between the each name pair.

17. The computer-readable media of claim 15, wherein the name pair data vectors define which of the features agree for the name pairs.

18. The computer-readable media of claim 15, wherein the decision model is trained by performing a hyperparameter tuning using multiple versions of the training dataset that are balanced using different boosting levels.

19. The computer-readable media of claim 15, wherein the decision model is evaluated by calculating a Positive Predictive Value (PPV) of the decision model.

20. The computer-readable media of claim 15, wherein the decision model is evaluated by preparing precision-recall curves of the decision model.
